(19) United States
(12) Patent Application Publication
(10) Pub. No.: US 2026/0017547 A1
(43) Pub. Date: Jan. 15, 2026

(54) MAGNUS EXPANSION IN INTERACTION PICTURE FOR QUANTUM SIMULATION

(71) Applicant: International Business Machines Corporation, Armonk, NY (US)

(72) Inventors: Kunal Sharma, White Plains, NY (US); Minh Tran, Cambridge, MA (US)

(21) Appl. No.: 18/618,384

(22) Filed: Mar. 27, 2024

(51) Int. Cl. G06N 10/20

(52) U.S. Cl. CPC G06N 10/20

(57) ABSTRACT

Systems and techniques that facilitate quantum simulation by using a Magnus expansion in an interaction picture are provided. One or more embodiments described herein can comprise a system, which can comprise a memory that can store computer executable components. The system can also comprise a processor, operably coupled to the memory that can execute the computer executable components stored in memory. The computer executable components can comprise a quantum circuit generation component that generates a quantum circuit that represents a quantum model of a quantum system, wherein generating of the quantum circuit can comprise decomposing a time-independent Hamiltonian that describes the quantum system into a first Hamiltonian and a second Hamiltonian. Generating of the quantum circuit can further comprise employing a Magnus expansion in an interaction picture of the first Hamiltonian to approximate a time evolution of the quantum system under a time-dependent Hamiltonian.

### BACKGROUND

The subject disclosure relates to quantum simulation, and more specifically, to quantum simulation by using a Magnus expansion in an interaction picture.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate quantum simulation by using a Magnus expansion in an interaction picture are provided.

According to an embodiment, a system can comprise a processor that executes computer executable components stored in memory. The computer executable components can comprise a quantum circuit generation component that generates a quantum circuit that represents a quantum model of a quantum system, wherein generating of the quantum circuit can comprise decomposing a time-independent Hamiltonian that describes the quantum system into a first Hamiltonian and a second Hamiltonian. Generating of the quantum circuit can further comprise employing a Magnus expansion in an interaction picture of the first Hamiltonian to approximate a time evolution of the quantum system under a time-dependent Hamiltonian. An advantage of this system is that it reduces error and quantum hardware requirements in quantum simulation.

According to another embodiment, a computer-implemented method can comprise generating, by a system operatively coupled to a processor, a quantum circuit that represents a quantum model of a quantum system, wherein generating of the quantum circuit can comprise decomposing, by the system, a time-independent Hamiltonian that describes the quantum system into a first Hamiltonian and a second Hamiltonian. Generating of the quantum circuit can further comprise employing, by the system, a Magnus expansion in an interaction picture of the first Hamiltonian to approximate a time evolution of the quantum system under a time-dependent Hamiltonian. An advantage of this computer-implemented method is that it reduces error and quantum hardware requirements in quantum simulation.

According to another embodiment, a computer program product comprising a computer readable storage medium having program instructions embodied therewith, the program instructions executable by a processor to cause the processor to generate, by the processor, a quantum circuit that represents a quantum model of a quantum system, wherein generating of the quantum circuit can comprise decomposing, by the processor, a time-independent Hamiltonian that describes the quantum system into a first Hamiltonian and a second Hamiltonian. Generating of the quantum circuit can further comprise employing, by the processor, a Magnus expansion in an interaction picture of the first Hamiltonian to approximate a time evolution of the quantum system under a time-dependent Hamiltonian. An advantage of this computer program product is that it reduces error and quantum hardware requirements in quantum simulation.

### DESCRIPTION OF THE DRAWINGS

FIG. 1 illustrates block diagram of an example, non-limiting system that can facilitate quantum simulation by using a Magnus expansion in an interaction picture in accordance with one or more embodiments described herein.

FIG. 2 illustrates block diagram of an example, non-limiting system that can facilitate quantum simulation by using a Magnus expansion in an interaction picture in accordance with one or more embodiments described herein.

FIG. 3 illustrates a block diagram of an example, non-limiting quantum system that can at least partially facilitate quantum simulation by using a Magnus expansion in an interaction picture in accordance with one or more embodiments described herein.

FIG. 4 illustrates a non-limiting example diagram of trotter formulas for quantum simulation using a Magnus expansion in an interaction picture in accordance with one or more embodiments described herein.

FIGS. 5 illustrates a non-limiting example diagram of simulation error of quantum simulation using a Magnus expansion in an interaction picture in accordance with one or more embodiments described herein.

FIG. 6 illustrates a non-limiting example diagram of gate count for quantum simulation using a Magnus expansion in an interaction picture in accordance with one or more embodiments described herein.

FIG. 7 illustrates a flow diagram of an example, non-limiting, computer implemented method that facilitates quantum simulation by using a Magnus expansion in an interaction picture in accordance with one or more embodiments described herein.

FIGS. 8 illustrates a flow diagram of an example, non-limiting, computer implemented method that facilitates quantum simulation by using a Magnus expansion in an interaction picture in accordance with one or more embodiments described herein.

FIGS. 9 illustrates a flow diagram of an example, non-limiting, computer implemented method that facilitates quantum simulation by using a Magnus expansion in an interaction picture in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a processor that executes computer executable components stored in memory. The computer executable components can comprise a quantum circuit generation component that generates a quantum circuit that represents a quantum model of a quantum system, wherein generating of the quantum circuit can comprise a decomposing a time-independent Hamiltonian that describes the quantum system into a first Hamiltonian and a second Hamiltonian. Generating of the quantum circuit can further comprise employing a Magnus expansion in an interaction picture of the first Hamiltonian to approximate a time evolution of the quantum system under a time-dependent Hamiltonian. An advantage of this system is that it reduces error and quantum hardware requirements in quantum simulation.

In one or more embodiments of the aforementioned system, the computer executable components can further comprise a truncation component that can truncate the Magnus expansion by a truncation parameter to create a truncated Magnus expansion. In some embodiments of the aforementioned system, the truncation component can identify the truncation parameter informed by the Lieb-Robinson bounds. In one or more embodiments of the aforementioned system, the truncation component can obtain a Pauli decomposition of the truncated Magnus expansion. In various embodiments of the aforementioned system, the computer executable components can further comprise an approximation component that reformulates the time evolution as a product of a first operator and a second operator, wherein the first operator describes a time evolution under the first Hamiltonian, and wherein the second operator is a time evolution generated by an interaction-picture Hamiltonian. In some embodiments of the aforementioned system, the approximation component can employ the truncated Magnus expansion to approximate the time evolution generated by the interaction-picture Hamiltonian. In one or more embodiments of the aforementioned system, the first Hamiltonian and the second Hamiltonian are geometrically local Hamiltonians. More generally, the second Hamiltonian can be considered as a k-local Hamiltonian. In some embodiments of the aforementioned system, the computer executable components can further comprise an execution component that employs Trotter formulas to implement the time evolution under the first Hamiltonian and the Pauli decomposition of the truncated Magnus expansion corresponding to the interaction-picture Hamiltonian in the quantum circuit, and executes the quantum circuit using a quantum processor to simulate the quantum model of the quantum system. Advantages of this system include reducing circuit depth and quantum gates for quantum simulation. Advantages of this system further include reducing computational costs, improving efficiency, and/or improving performance of quantum simulation. Advantages of this system even further include eliminating time-keeping logic in quantum simulation and controlled unitaries, and thus eliminating needs for ancillary qubits.

According to some embodiments, the above-described computer system can be implemented as a computer-implemented method or as a computer program product.

In quantum computing, quantum simulation is a technique to simulate or approximate behaviors of a quantum system that cannot be computed on a classical computer. Quantum simulation can be desirable for various research and development purposes (e.g., quantum optics, molecular structure simulation, cryptography, biological neural networks, materials science). A quantum system (e.g., chemical reactions, spin systems, quantum ecology systems) can be simulated by executing a quantum circuit to simulate a quantum model that represents the quantum system, wherein the quantum model describes dynamics and interactions of the quantum system. A quantum simulation circuit approximates a unitary operation corresponding to a time evolution under a Hamiltonian. Hamiltonians model the energy and dynamics of quantum systems. Designing and implementing Hamiltonians tailored to specific quantum systems allows for simulation of a wide range of applications. Furthermore, time evolutions of quantum systems are a fundamental aspect of quantum simulation, representing how a quantum state changes over time according to the quantum system's Hamiltonian. Accordingly, it can be desirable to approximate time evolutions to observe how a system evolves from an initial state to a final state under the influence of a specific Hamiltonian (e.g., Schrödinger equation to describe time evolution, showing how a state of a quantum system evolves deterministically from an initial state). This process allows for studying of a system's properties and behavior over time without physically creating the system itself. However, quantum simulation is prone to errors (e.g., noise, decoherence) which can affect accuracy of simulation results. Moreover, quantum simulation can necessitate high circuit depths (e.g., number of quantum operations needed to execute a quantum circuit). High circuit depth can lead to increased susceptibility to errors and longer computation times. Additionally, gate count, (e.g., number of quantum gates used in a quantum circuit to perform a computation or simulation), can be significant for complex simulations, posing scalability and resource limitation issues. High circuit depths gate counts can require more qubits and quantum resources, which may exceed capabilities of current quantum hardware, limiting size and complexity of simulations that can be feasibly performed.

In view of the problems discussed above, in relation to quantum circuit simulation, the present disclosure can be implemented to produce a solution to one or more of these problems by decomposing a time-independent Hamiltonian into a first Hamiltonian and second Hamiltonian, and employing a Magnus expansion in an interaction picture of the first Hamiltonian to approximate a time evolution under a time-dependent Hamiltonian. Magnus expansion is a mathematical technique to approximate a time evolution of operators in a quantum system by providing a systematic way to compute an exponential of an operator (e.g., often encountered when solving time-dependent Schrödinger equations). The Magnus expansion expresses the exponential of an operator as a sum of terms involving nested commutators, allowing for a perturbative approach to solving quantum mechanical problems. By decomposing the time-independent Hamiltonian into the first Hamiltonian and the second Hamiltonian, a representation of the time-independent Hamiltonian that can be classically computed can be obtained.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

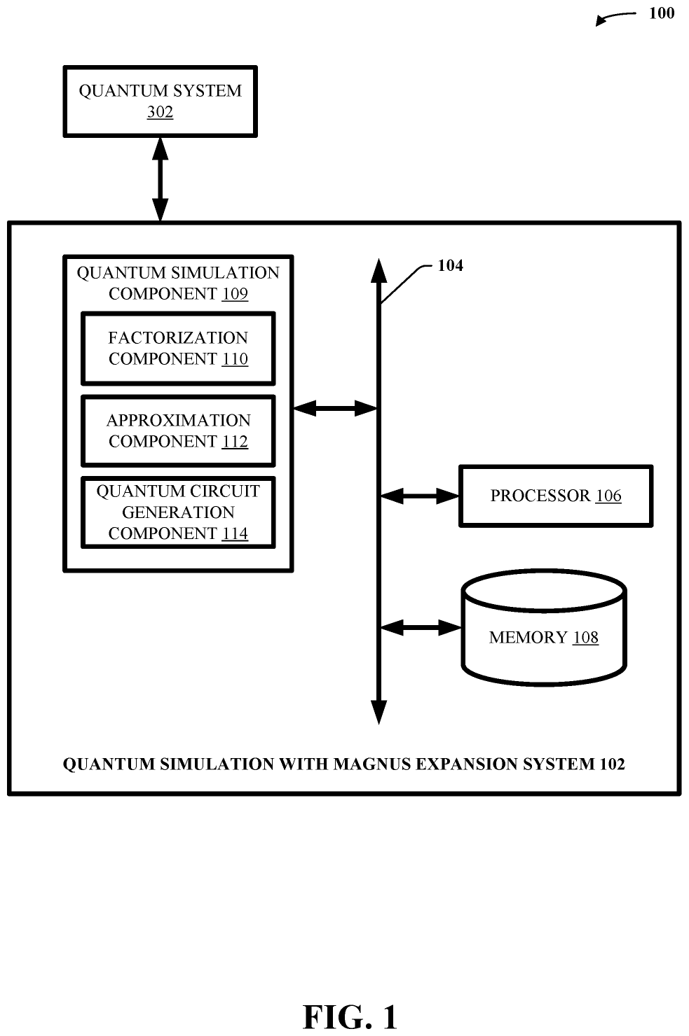

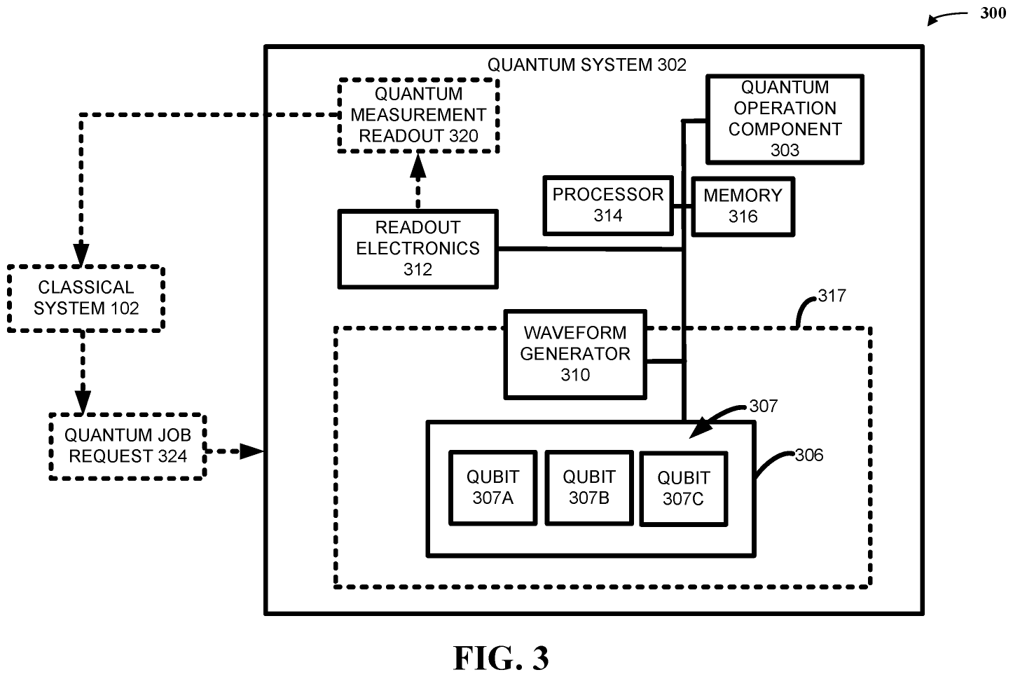

FIG. 1 illustrates block diagram of an example, non-limiting system 100 that can facilitate quantum simulation by using a Magnus expansion in an interaction picture in accordance with one or more embodiments described herein. That is, the non-limiting system 100 can facilitate quantum simulation by using a Magnus expansion, in combination with employment of a quantum system 302 (FIG. 3B).

Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise system bus 104, processor 106, memory 108, factorization component 110, and approximation component 112.

The system 100 and/or the components of the system 100 can be employed to use hardware and/or software to solve problems that are highly technical in nature (e.g., related to multiple kernel learning, classification, structured data learning, etc.), that are not abstract and that cannot be performed as a set of mental acts by a human. Further, some of the processes performed may be performed by specialized computers for carrying out defined tasks related to quantum machine learning. The system 100 and/or components of the system can be employed to solve new problems that arise through advancements in technologies mentioned above, computer architecture, and/or the like. The system 100 can provide technical improvements to quantum simulation by reducing circuit depth needed for quantum simulation, improving Hamiltonian dynamics simulation, reducing quantum simulation errors, and/or hardware efficiency of quantum simulation etc.

Discussion turns briefly to processor 106, memory 108 and bus 104 of system 100. For example, in one or more embodiments, the system 100 can comprise processor 106 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 106 to enable performance of one or more processes defined by such component(s) and/or instruction(s).

In one or more embodiments, system 100 can comprise a computer-readable memory (e.g., memory 108) that can be operably connected to the processor 106. Memory 108 can store computer-executable instructions that, upon execution by processor 106, can cause processor 106 and/or one or more other components of system 100 (e.g., quantum simulation component 109, factorization component 110, approximation component 112, and/or quantum circuit generation component 114) to perform one or more actions. In one or more embodiments, memory 108 can store computer-executable components (e.g., quantum simulation component 109, factorization component 110, approximation component 112, and quantum circuit generation component 114).

System 100 and/or a component thereof as described herein, can be communicatively, electrically, operatively, optically and/or otherwise coupled to one another via bus 104. Bus 104 can comprise one or more of a memory bus, memory controller, peripheral bus, external bus, local bus, and/or another type of bus that can employ one or more bus architectures. One or more of these examples of bus 104 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 106 and/or memory 108 described above, system 100 can comprise one or more computer and/or machine readable, writable and/or executable components and/or instructions that, when executed by processor 106, can enable performance of one or more operations defined by such component(s) and/or instruction(s).

In various embodiments the quantum simulation component 109 can comprise sub-components that can comprise the factorization component 110, the approximation component 112, and/or the quantum circuit generation component 114. In some aspects, the sub-components (e.g., factorization component 110, approximation component 112, and/or quantum circuit generation component 114) can be implemented independently without the other sub-components. In various cases, two or more of the sub-components can be combined into a single component.

In various embodiments, the quantum circuit generation component 114 can generate a quantum circuit that represents a quantum model of a quantum system. According to some embodiments, the quantum model can comprise n qubits on a 1-dimensional regular lattice ∧ (e.g., linear chain, square grid, cubic lattice). In various embodiments, there can be a time-independent Hamiltonian H, where it is desirable to simulate (e.g., approximate) a time evolution [symbol] (t) of a quantum state of the quantum system with respect to H using the quantum circuit. The time-independent Hamiltonian is a classical description of a Hamiltonian for a particular quantum model. For example, the time-independent Hamiltonian can be a Pauli matrix or a linear combination of Pauli matrices. The time evolution can be defined by the following equation:

$$𝒰 ( t ) = {e}^{- iHt}$$

The time evolution [symbol] (t) is a unitary operator where t denotes time.

In one or more embodiments, the factorization component 110 can decompose the time-independent Hamiltonian H into a first Hamiltonian H₁ and a second Hamiltonian H₂, such that H=H₁+H₂, where ∥H₁∥>>∥H₂∥, and we denote ∥H₂∥/∥H₁∥=s. In various aspects, the first Hamiltonian and the second Hamiltonian can be geometrically local Hamiltonians. A Hamiltonian H is geometrically local if there is a decomposition

$$H = {\sum }_{i = 1}^{n} {H}_{i}$$

such that Hᵢ supported entirely on a neighborhood of radius x=0(1) around i, where x is an interaction range of H (e.g., if x=1, H is a sum of nearest-neighbor interactions). Furthermore, it is assumed that spectral norm ∥Hᵢ∥≤1 for every site i (e.g., largest singular value of Hᵢ is bounded by 1).

In one or more embodiments, the approximation component 112 can employ Magnus expansion in an interaction picture (e.g., representation used in quantum mechanics to simplify analysis of time-dependent systems) to approximate the time evolution. More specifically, the approximation component 112 can move into the interaction picture with respect to the first Hamiltonian (e.g., defining a new set of operators where the time evolution is driven by H₁). Accordingly, instead of simulating H₂ directly, H₂ evolved under H₁ is simulated. Interaction pictures provide a way to split a Hamiltonian into a time-independent Hamiltonian and a time-dependent Hamiltonian (e.g., interaction Hamiltonian). After moving into the interaction picture with respect to the first Hamiltonian, the time evolution [symbol] (t) can be equivalently re-defined by the following equation:

$$𝒰 ( t ) = {e}^{- iHt} = {𝒰}_{{H}_{1}} ( t ) {𝒰}_{{H}_{2} I} ( t ) = {e}^{- {iH}_{1} t} 𝒯 [ {e}^{- i {\int }_{0}^{t} {H}_{I} ( t ) d τ} ]$$

H₁(τ) denotes an interaction-picture Hamiltonian where H₁(τ)=e^{iH}^{₁}^{τ}H₂e^{-iH}^{₁}^{τ}

In other words, the approximation component 112 can reformulate the time evolution [symbol] (t) as a product of a first operator and a second operator. More specifically, the first operator is the time evolution under the first Hamiltonian (e.g., [symbol] _{H}_{₁}(t)) and the second operator is the evolution generated by the interaction-picture Hamiltonian (e.g., [symbol] _{H}_{₂}^{I}(t)).

In various aspects, the approximation component 112 can employ the Magnus expansion to approximate the interaction-picture Hamiltonian H₁(τ). The Magnus expansion states that there exists an operator

$$Ω ( t ) \approx {\sum }_{j = 1}^{∞} {Ω}_{j} ( t )$$

such that

$$𝒯 [ {e}^{- i {\int }_{0}^{t} {H}_{I} ( τ ) d τ} ] = {e}^{Ω ( t )}$$

where Ωⱼ(t) depends on nested commutators between terms of interaction-picture Hamiltonian H₁(τ). In various aspects, e^{Ω(t)} is a representation of a time-ordered exponential of H₂ evolved under H₁. In various embodiments, due to the Magnus expansion containing an infinite sum of terms, the Magnus expansion can be truncated by a truncation parameter q, wherein the first q terms of the infinite sum are retained for approximation. For example, for q=1 (e.g., first-order Magnus expansion), the Magnus expansion is truncated to form a truncated Magnus expansion Ω₁(t). However, the approximation component 112 can truncate the Magnus expansion by any suitable truncation parameter q. For example, the truncation parameter can be determined based on a desired level of accuracy in the quantum simulation. As another example, the truncation parameter can be determined based on depth of the quantum circuit.

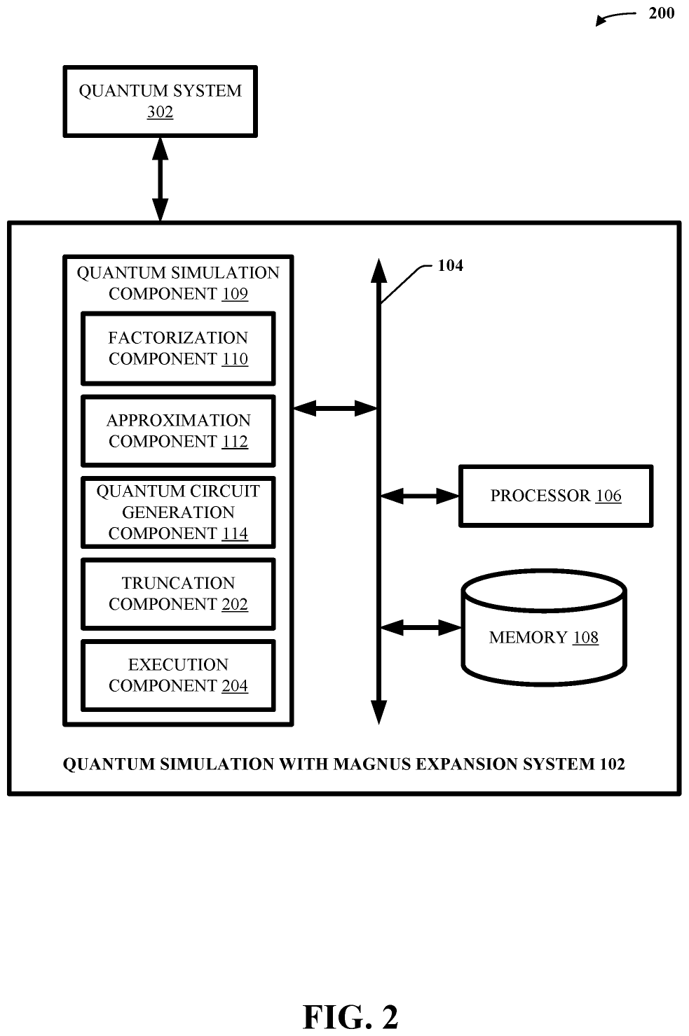

FIG. 2 illustrates block diagram of an example, non-limiting system 200 that can facilitate quantum simulation by using a Magnus expansion in an interaction picture in accordance with one or more embodiments described herein. Repetitive description of like elements employed in other embodiments described herein is omitted for sake of brevity. As shown, quantum simulation with Magnus expansion system 102 can, in some cases, further comprise a truncation component 202 and an execution component 204.

In various embodiments, the approximation component 112 can engage the truncation component 202 to truncate the Magnus expansion by the truncation parameter to create the truncated Magnus expansion. In various aspects, the truncation component 202 can identify a suitable truncation parameter q. More specifically, for t=0(1), the Truncated Magnus expansion can be computed efficiently by Lieb-Robinson bounds (e.g., set of mathematical constraints that describe how information or correlations can propagate in quantum many-body systems) for any constant j. Therefore, computation of the truncated Magnus expansion can be computed classically using a classical processor. The truncated Magnus expansion can be denoted by

$$\overline{Ω} ( t ) ≡ {\sum }_{j = 1}^{q} {Ω}_{q} ( t ) .$$

Classical computation of the truncated Magnus expansion can provide an advantage of reducing quantum registers for computation and eliminating use of complex time-keeping logic.

In various aspects, the approximation component 112 can approximate the time evolution using a q-th order Magnus expansion with the following equation:

$$𝒰 ( t ) = {e}^{- iHt} \approx {e}^{- i {H}_{1} t} {e}^{\overline{Ω} ( t )}$$

In some embodiments, the approximation component 112 can engage the truncation component 202 to obtain a Pauli decomposition of the truncated Magnus expansion for a fixed time. The Pauli decomposition can enable implementation of the truncated Magnus expansion on a quantum simulation circuit because quantum gates are typically defined based on single or double qubit gates, which are defined in terms of Pauli operators. In various aspects, the approximation component 112 can engage the truncation component 202 to approximate the truncated Magnus expansion by a geometrically local truncated Magnus expansion Ω̅_{loc}(t). In some embodiments, the approximation component 112 can determine the geometrically local truncated Magnus expansion by removing terms outside the interaction range.

The geometrically local truncated Magnus expansion can enable efficient estimation of the Pauli decomposition due to its locality. More specifically, the locality enables efficient computation of the Pauli decomposition because Pauli terms, being local operators that act on nearby qubits, allow for computations to be performed independently on smaller subsets of qubits, thereby reducing computational complexity by leveraging local interactions within the quantum system. In various cases, any suitable method to classically compute the Pauli decomposition can be employed (e.g., matrix multiplication, tensor products, randomized sampling, sparse representations, Monte Carlo methods, known relations).

In various embodiments, the execution component 204 can employ, but is not limited to, Trotterization to implement and execute the Pauli decomposition on the quantum circuit for simulation of the time evolution. In various cases, any suitable method to implement the Pauli decomposition on the quantum circuit can be employed. In some instances, the method to implement the Pauli decomposition on the quantum circuit can be selected based on various factors, such as circuit depth or quantum resources. The quantum circuit can then be sent to a quantum computer or to a quantum simulator to be run.

Turning to FIG. 3, one or more embodiments described herein can include one or more devices, systems and/or apparatuses that can provide a process to facilitate quantum simulation with Magnus expansion. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 302 that can be employed with or separate from the classical system 102.

Generally, the quantum system 302 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 302 can comprise components, such as a quantum operation component 303, a quantum processor 306, pulse component 410 (e.g., a waveform generator) and/or a readout electronics 312 (e.g., readout component). In one or more other embodiments, the readout electronics 312 can be comprised at least partially by the classical system 101 and/or be external to the quantum system 302. The quantum processor 306 can comprise one or more, such as plural, qubits 307. Individual qubits 307A, 307B and 307C, for example, can be fixed frequency and/or single junction qubits, such as transmon qubits.

In one or more embodiments, a memory 316 and/or processor 314 can be associated with the quantum operation component 303, where suitable. The processor 314 can be any suitable processor. The processor 314 can generate one or more instructions for controlling the one or more processes of the quantum operation component 303.

The quantum operation component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 302, such as a by a component of the classical system 101.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 302.

The quantum processor 306 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 307. Where the plurality of qubits 307 are superconducting qubits, cryogenic temperatures, such as about 4K or lower, can be employed for function of these physical qubits. Accordingly, one or more elements of the readout electronics 312 also can be constructed to perform at such cryogenic temperatures.

The readout electronics 312, or at least a portion thereof, can be contained in the cryogenic environment 317, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

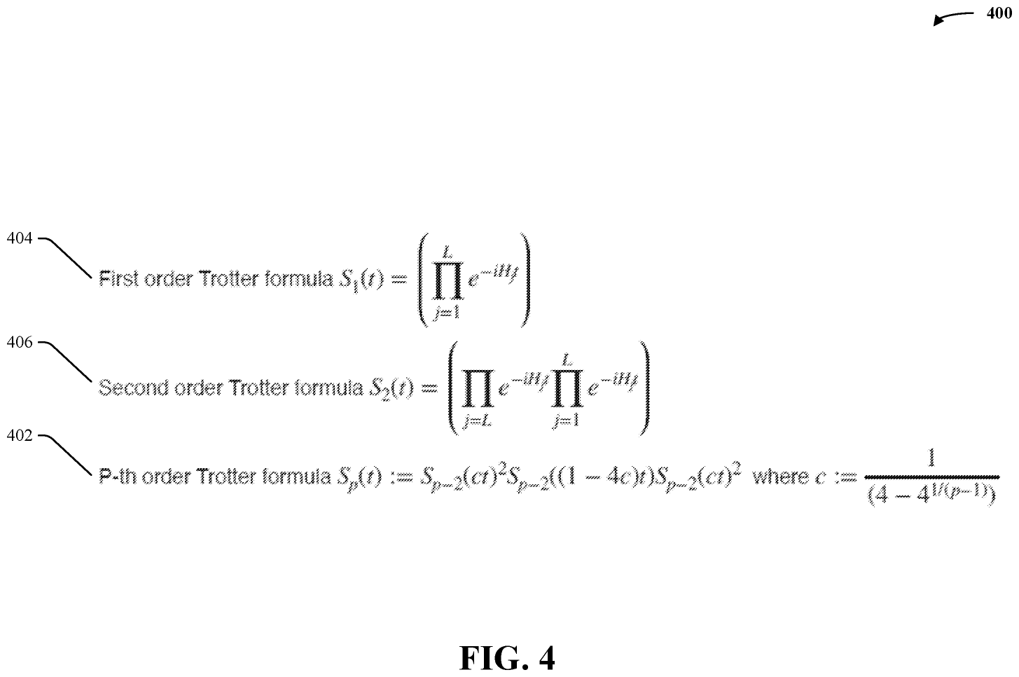

FIG. 4 illustrates a non-limiting example diagram 400 of Trotter formulas for quantum simulation using a Magnus expansion in an interaction picture in accordance with one or more embodiments described herein. Repetitive description of like elements employed in other embodiments described herein is omitted for sake of brevity.

As a non-limiting example, the execution component 204 can employ p-th order Trotter formulas to implement and execute the time evolution under the first Hamiltonian and the Pauli decomposition of the truncated Magnus expansion in the quantum circuit. A p-th order Trotter formula for implementing the Pauli decomposition is depicted by 402. First and second order Trotterization, for example, can be employed using first order Trotter formula 404 and second order trotter formula 406 to approximate

$${e}^{{\sum }_{j = 1}^{q} {Ω}_{j} ( t )}$$

and e^{-iH}^{₁}^{t} . Therefore, in the case of first-order Magnus expansion, the first and second order Trotter approximation of e^{Ω}^{₁}^{(t)} can be denoted by V₁ and V₂ respectively, and the first and second order Trotter approximation of e^{-iH}^{₁}^{t} can be denoted by W₁ and W₂ respectively. Thus, the first and second order Magnus expansion approximations can be defined by D₁=W₁·V₁ and D₂=W₂·V₂ respectively. Note that in general, the Magnus expansion can be truncated at any q-th order and the corresponding Pauli decomposition can be approximated using a generic p-th order Trotter approximation.

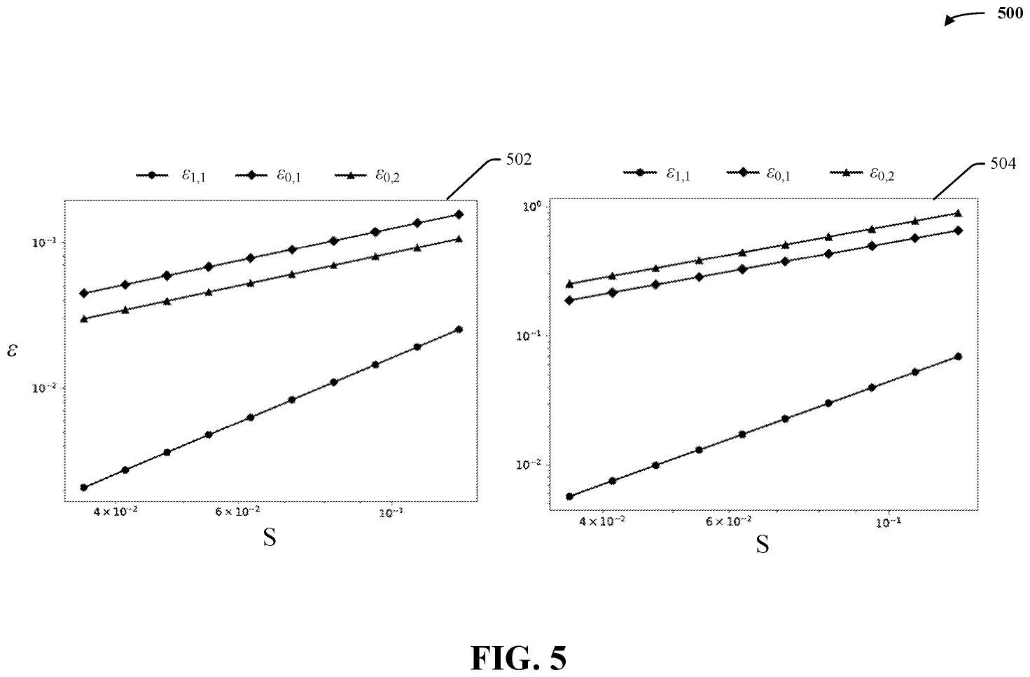

FIG. 5 illustrates a non-limiting example diagram 500 of simulation error of quantum simulation using a Magnus expansion in an interaction picture in accordance with one or more embodiments described herein. Repetitive description of like elements employed in other embodiments described herein is omitted for sake of brevity.

In various aspects, error of quantum simulation using a Magnus expansion in an interaction picture can be defined by three errors. As a non-limiting example, for a first-order Magnus expansion with a Trotter method, the error in Magnus approximation can be defined by:

$$‖ {e}^{- iHt} - {U}_{magnus} ‖ \leq ‖ {e}^{- {iH}_{1} t} - W ‖ + ‖ {e}^{Ω ( t )} - {e}^{{Ω}_{1} ( t )} ‖ + ‖ {e}^{Ω1 ( t )} - V ‖$$

where an ideal evolution

$${e}^{- iHt} = {e}^{- {iH}_{1} t} 𝒯 [ {e}^{- i {\int }_{0}^{t} {H}_{I} ( τ ) d τ} ] .$$

A first error, a second error, and a third error can be described by ∥e^{-iH}^{₁}^{t}−W∥, ∥e^{Ω(t)}−e^{Ω}^{₁₍ₜ₎}∥and ∥e^{Ω1(t)}−V ∥ respectively. The first error corresponds to error of the time evolution under the first Hamiltonian. The second error corresponds to the Magnus expansion and truncating of the Magnus expansion. The third error corresponds to error of Pauli decomposition for Magnus expansion approximation. The error in Magnus approximation depends on time t and an error scaling factor s. The first error can be assumed to be efficiently and accurately approximated, and thus can be considered as 0 for simplicity. Further, more generally, the first error can be assumed to have a smaller error than the second error (e.g., when H₁ comprises single-qubit terms, fast forwardable Hamiltonians). The second error and the third error with an error dependence on t and s can be given by [symbol] (s²t³) and [symbol] (s²t²) respectively. Here, we considered the case when V is approximated by a first-order Trotter formula. More generally, the second error of Magnus expansion approximation can be given by [symbol] ((st)^{q+1}t) at a q-th order Magnus expansion. Accordingly, for scaling factors smaller than 1, Magnus approximation achieves reduced error in near-term settings in comparison to the Trotter method without Magnus approximation (e.g., third error given by [symbol] (st²)). Although error is mainly discussed for a first-order Magnus expansion for simplicity, such error reduction is not limited to the first-order Magnus expansion. Such advantages of error reduction can result from any p-th order Magnus expansion.

Illustrated in graph 502 and graph 504 are log-log plots depicting simulation errors ε_{1,1}, ε_{0,1}, and ε_{0,2} corresponding to a first-order Magnus with first-order Trotter, a first-order Trotter of the original Hamiltonian, and a second-error Trotter of the original Hamiltonian, respectively. In graph 502 and graph 504, 6 qubits are considered. Furthermore, the simulation is performed using a first-order Trotter circuit with a circuit depth of 10 and 2 Trotter steps, each comprising a time step of t/2. The simulation is further performed using a second-order Trotter circuit with a circuit depth of 9 and 1 Trotter step for time t. The simulation is even further performed using Magnus expansion approximation with a circuit depth of 9, where first-order Magnus expansion approximation is employed and approximated using a first-order product formula. The simulation errors in graph 502 are errors in simulating e^{-iHt} for t=0.5. The simulation errors in graph 504 are errors in simulating e^{-iHt} for t=1. As shown, the Magnus expansion approximation achieves a significant reduction in error in comparison to the first-order Trotter and the second-error Trotter for t=0.5 and t=1, due to the Magnus expansion approximation scaling as s².

In an asymptotic setting, quantum simulation with Magnus expansion exhibits an improved simulation error than Trotter approximation alone. More specifically, for a q-th order Magnus expansion approximation with q-th order Trotter implementation, an upper bound on the simulation error scales as [symbol] ((st)^{q+1}), whereas simulation error in q-th order product formula scales as [symbol] (st^{q+1}).

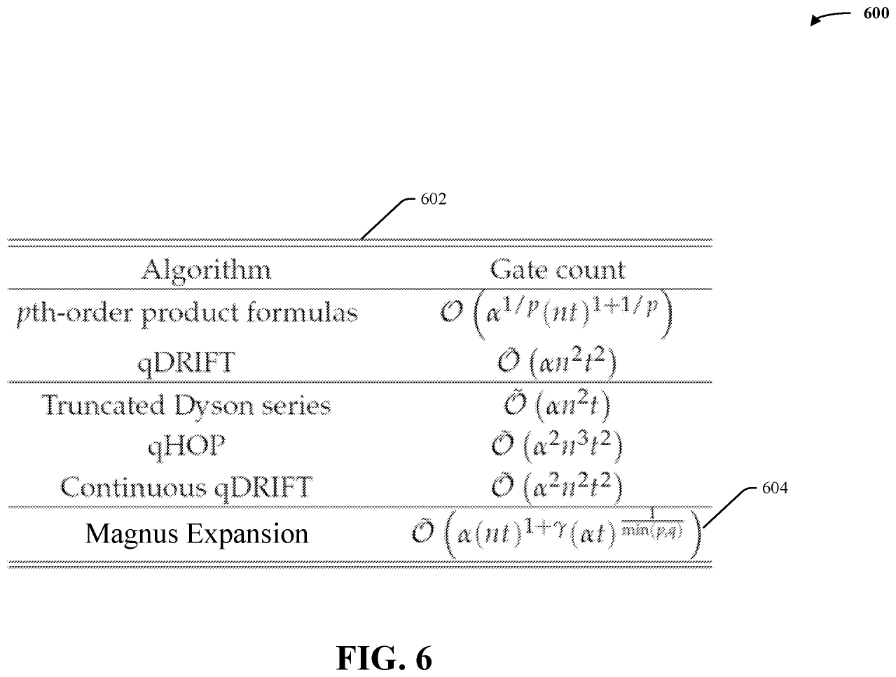

FIG. 6 illustrates a non-limiting example diagram 600 of gate count for quantum simulation using a Magnus expansion in an interaction picture in accordance with one or more embodiments described herein. Repetitive description of like elements employed in other embodiments described herein is omitted for sake of brevity.

Illustrated in chart 602 are gate counts of existing methods for quantum simulation in comparison to quantum simulation by using q-th order Magnus expansion in the interaction picture, as described above in reference to FIGS. 1 and 2. Note that, α refers to s in chart 602. As shown, Magnus expansion achieves a gate count of

$$𝒪 ( {s ( n t )}^{1 + γ} {( st )}^{\frac{1}{min ( p , q )}} )$$

(e.g., 604). For γ=0 and large p,q, q-th order Magnus expansion achieves a linear dependence on s while performing as well as or better than the existing methods in scaling of n and t. In other words, q-th order Magnus expansion achieves dependence on s² with improved scaling of n and t while the existing methods achieve s or s² with higher scaling of n and t.

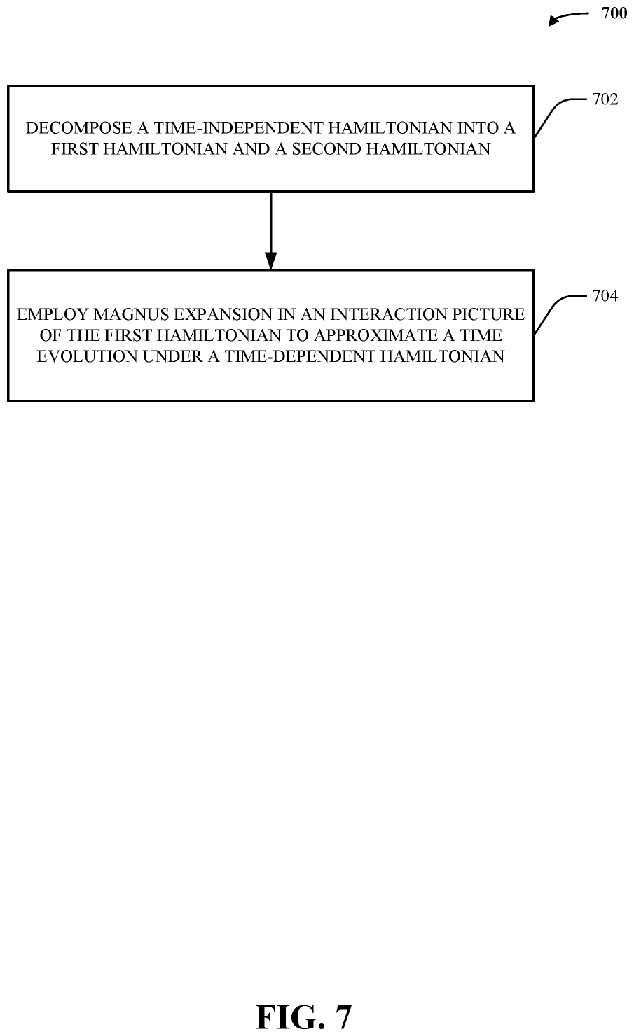

FIG. 7 illustrates a flow diagram of an example, non-limiting, computer implemented method 700 that facilitates quantum simulation by using a Magnus expansion in an interaction picture in accordance with one or more embodiments described herein. Repetitive description of like elements employed in other embodiments described herein is omitted for sake of brevity.

At 702, method 700 can comprise decomposing, by a system (e.g., factorization component 110) operatively coupled to a processor (e.g., processor 106), a time-independent Hamiltonian into a first Hamiltonian and a second Hamiltonian. As described in greater detail above in reference to FIGS. 1 and 2, the first Hamiltonian and the second Hamiltonian can be geometrically local. More generally, the second Hamiltonian can be assumed to be a k-local Hamiltonian.

At 704, method 700 can comprise employing, by the system (e.g., approximation component 112), Magnus expansion in an interaction picture of the first Hamiltonian to approximate a time evolution under a time-dependent Hamiltonian. As described above in greater detail in reference to FIGS. 1 and 2, the Magnus expansion can be truncated by a truncation parameter. In various cases, the truncation parameter can be determined, based on various factors (e.g., desired simulation accuracy, quantum circuit depths, quantum error), on a classical computer.

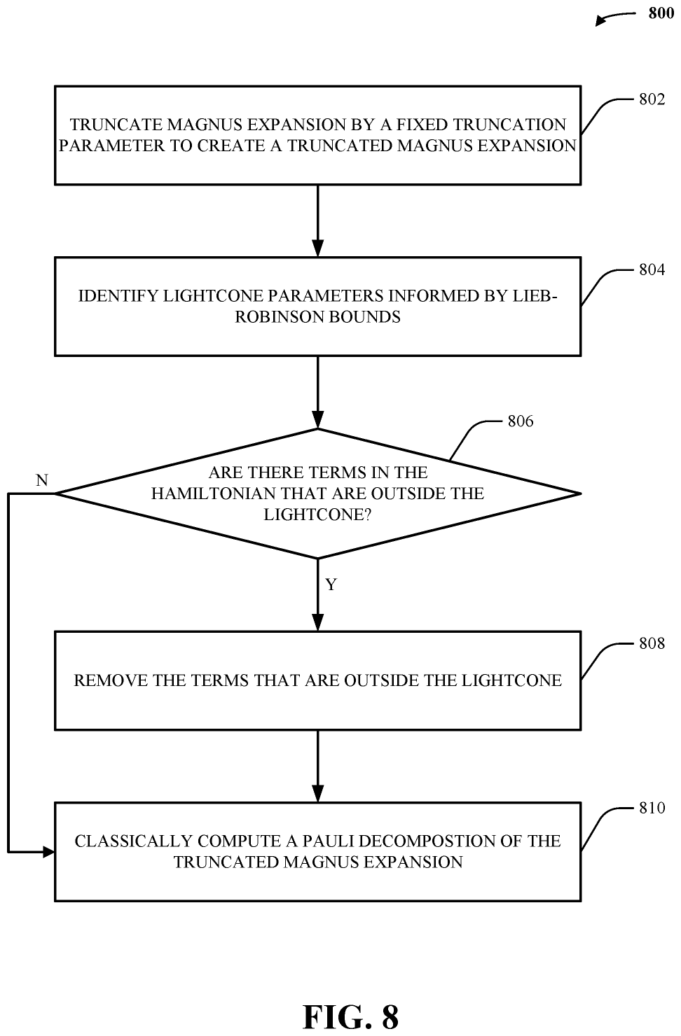

FIG. 8 illustrates a flow diagram of an example, non-limiting, computer implemented method 800 that facilitates quantum simulation by using a Magnus expansion in an interaction picture in accordance with one or more embodiments described herein. Repetitive description of like elements employed in other embodiments described herein is omitted for sake of brevity.

At 802, method 800 can comprise truncating, by the system (e.g., truncation component 202), the Magnus expansion by a fixed truncation parameter to create a truncated Magnus expansion.

At 804, method 800 can comprise identifying, by the system (e.g., truncation component 202), lightcone (e.g., region of spacetime within which information can be causally influenced by an operation performed on a qubit or a set of qubits) parameters informed by Lieb-Robinson bounds. As described above in greater detail in reference to FIGS. 1 and 2, the Lieb-Robinson bounds enable the truncated Magnus expansion to be efficiently and classically computed.

At 806, method 800 can comprise determining if there are terms in the Hamiltonian that are outside the lightcone. If so (e.g., there are terms in the Hamiltonian that are outside the lightcone), the method 800 can proceed to 808. If not (e.g., there are no terms in the Hamiltonian that are outside the lightcone), the method 800 can proceed to 810.

At 808, method 800 can comprise removing, by the system, (e.g., approximation component 112), the terms that are outside the lightcone. In various aspects, removing terms in the Hamiltonian that are outside the lightcone can maintain computational efficiency and accuracy of the truncated Magnus expansion, as it reduces complexity of simulation by focusing only on locally relevant interactions, ensuring that the simulation respects locality constraints of the quantum system.

At 810, method 800 can comprise classically computing, by the system, (e.g., truncation component 202), a Pauli decomposition of the truncated Magnus expansion. In some cases, a Pauli decomposition of the geometrically local truncated Magnus expansion can be classically computed. In any case, the Pauli decomposition can be implemented on the quantum circuit to simulate the time evolution of the quantum system.

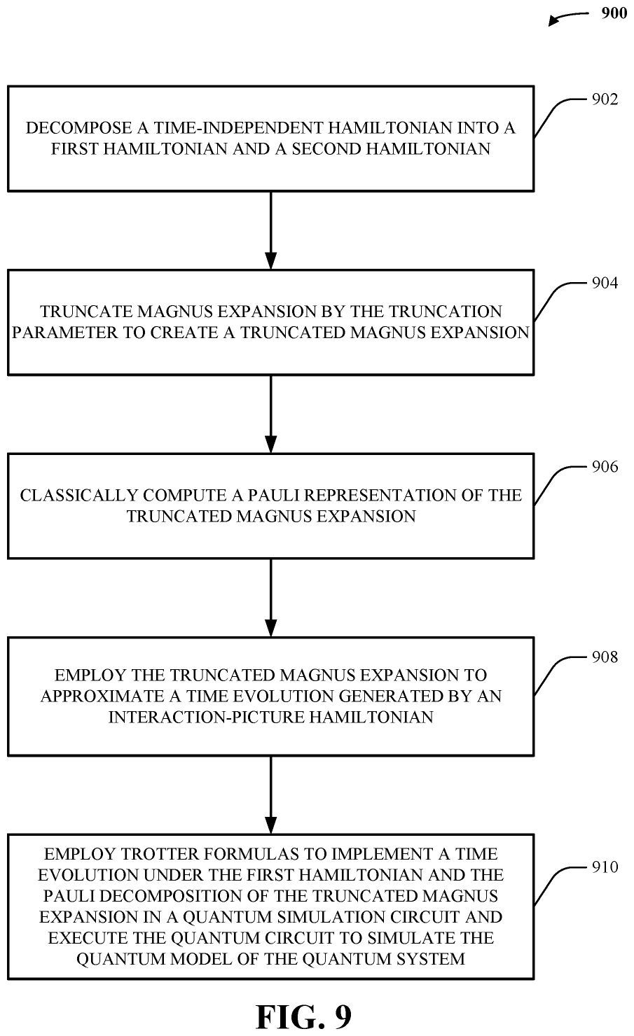

FIG. 9 illustrates a flow diagram of an example, non-limiting, computer implemented method 900 that facilitates quantum simulation by using a Magnus expansion in an interaction picture in accordance with one or more embodiments described herein. Repetitive description of like elements employed in other embodiments described herein is omitted for sake of brevity.

At 902, method 900 can comprise decomposing, by a system (e.g., factorization component 110) operatively coupled to a processor (e.g., processor 106), a time-independent Hamiltonian into a first Hamiltonian and a second Hamiltonian.

At 904, method 900 can comprise truncating, by the system (e.g., approximation component 112), the Magnus expansion by the truncation parameter to create a truncated Magnus expansion.

At 906, method 900 can comprise classically computing, by the system, (e.g., truncation component 202), a Pauli representation of the truncated Magnus expansion.

At 908, method 900 can comprise employing, by the system (e.g., approximation component 112), the truncated Magnus expansion to approximate a time evolution generated by an interaction-picture Hamiltonian.

At 910, method 900 can comprise employing, by the system (e.g., execution component 204), trotter formulas to implement a time evolution under the first Hamiltonian and the Pauli decomposition of the truncated Magnus expansion in a quantum simulation circuit. In various cases, p-th order trotter formulas can be employed for approximation. At 910, method 900 can further comprise executing, by the system (e.g., execution component 204) and a quantum processor, the quantum circuit to simulate the quantum model of the quantum system.

Quantum simulation with Magnus expansion system 102 can provide technical improvements to a processing unit associated with quantum simulation with Magnus expansion system 102. For example, by utilizing Magnus expansion, Pauli decompositions can be classically computed, thereby reducing the workload of a processing unit (e.g., processor 106) that is employed to execute routines (e.g., instructions and/or processing threads) involved in quantum computations. In this example, by reducing the workload of such a processing unit (e.g., processor 106), quantum simulation with Magnus expansion system 102 can thereby facilitate improved performance, improved efficiency, and/or reduced computational cost associated with such a processing unit. Further, by utilizing a Magnus expansion, circuit depth and gate count needed for quantum simulation by quantum simulation with Magnus expansion system 102 is reduced, thereby improving efficiency and/or reduced computational cost associated with such a processing unit.

A practical application of quantum simulation with Magnus expansion system 102 is that it allows for simulation of quantum circuits utilizing a reduced amount of computing and/or network resources, in comparison to other methods. For example, utilization of Magnus expansion in the interaction picture for quantum simulation reduces circuit depths needed for quantum simulation. Furthermore, by eliminating the requirement for time-keeping logic, the need for ancillary qubits is also eliminated, thereby reducing resource requirements, reducing gate counts, and mitigating crosstalk by the quantum simulation with Magnus expansion system 102. Therefore, quantum simulation with Magnus expansion system 102 can enable quantum simulation circuits to be operated with reduced quantum hardware requirements, thus promoting scalability of quantum systems. Furthermore, by reducing the number of gates needed in quantum simulation circuits while maintaining circuit accuracy, execution time of the quantum circuits is thereby reduced, improving performance of quantum simulators and/or quantum computers utilized in executing the quantum circuits.

It is to be appreciated that quantum simulation with Magnus expansion system 102 can utilize various combination of electrical components, mechanical components, and circuity that cannot be replicated in the mind of a human or performed by a human as the various operations that can be executed by quantum simulation with Magnus expansion system 102 and/or components thereof as described herein are operations that are greater than the capability of a human mind. For instance, the amount of data processed, the speed of processing such data, or the types of data processed by quantum simulation with Magnus expansion system 102 over a certain period of time can be greater, faster, or different than the amount, speed, or data type that can be processed by a human mind over the same period of time. According to several embodiments, quantum simulation with Magnus expansion system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum simulation with Magnus expansion system 102 can include information that is impossible to obtain manually by an entity, such as a human user. For example, the type, amount, and/or variety of information included in quantum simulation with Magnus expansion system 102 can be more complex than information obtained manually by an entity, such as a human user.

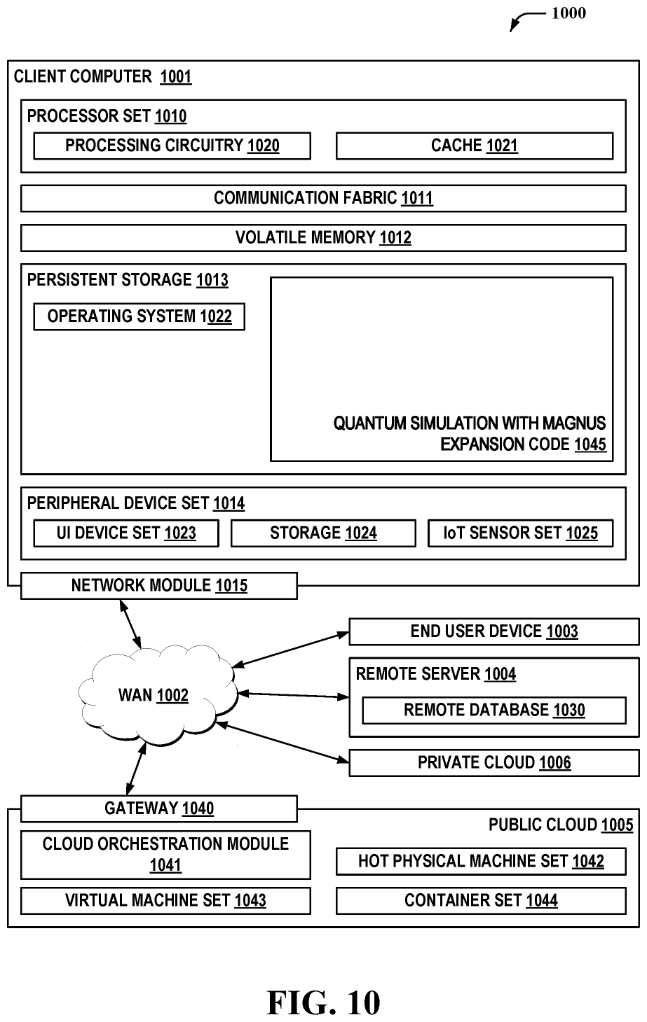

FIG. 10 and the following discussion are intended to provide a brief, general description of a suitable computing environment 1000 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“ CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as approximation of a time evolution of the quantum system under a time-dependent Hamiltonian by the quantum simulation with Magnus expansion code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1045 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising: a memory that stores computer executable components; and
a processor that executes the computer executable components stored in the memory, wherein the computer executable components comprise:
a quantum circuit generation component that generates a quantum circuit that represents a quantum model of a quantum system, wherein generating of the quantum circuit comprises:
decomposing a time-independent Hamiltonian that describes the quantum system into a first Hamiltonian and a second Hamiltonian; and
employing a Magnus expansion in an interaction picture of the first Hamiltonian to approximate a time evolution of the quantum system under a time-dependent Hamiltonian.

2. The system of claim 1, further comprising:
a truncation component that truncates the Magnus expansion by a truncation parameter to create a truncated Magnus expansion.

3. The system of claim 2, wherein the truncation component identifies the truncation parameter informed by Lieb-Robinson bounds.

4. The system of claim 2, wherein the truncation component generates a Pauli decomposition of the truncated Magnus expansion.

5. The system of claim 4, further comprising:
an approximation component that reformulates the time evolution as a product of a first operator and a second operator, wherein the first operator describes a time evolution under the first Hamiltonian, and wherein the second operator is a time evolution generated by an interaction-picture Hamiltonian.

6. The system of claim 5, wherein the approximation component employs the truncated Magnus expansion to approximate the time evolution generated by the interaction-picture Hamiltonian.

7. The system of claim 1, wherein the first Hamiltonian and the second Hamiltonian are geometrically local Hamiltonians.

8. The system of claim 5, further comprising:
an execution component that employs Trotter formulas to implement the time evolution under the first Hamiltonian and the Pauli decomposition of the truncated Magnus expansion corresponding to the interaction-picture Hamiltonian in the quantum circuit, and executes the quantum circuit using a quantum processor to simulate the quantum model of the quantum system.

9. A computer-implemented method, comprising:
generating, by a system operatively coupled to a processor, a quantum circuit that represents a quantum model of a quantum system, wherein generating of the quantum circuit comprises:
decomposing, by the system, a time-independent Hamiltonian that describes the quantum system into a first Hamiltonian and a second Hamiltonian; and
employing, by the system, a Magnus expansion in an interaction picture of the first Hamiltonian to approximate a time evolution of the quantum system under a time-dependent Hamiltonian.

10. The computer-implemented method of claim 9, further comprising:
truncating, by the system, the Magnus expansion by a truncation parameter to create a truncated Magnus expansion.

11. The computer-implemented method of claim 10, further comprising:
identifying, by the system, the truncation parameter informed by Lieb-Robinson bounds.

12. The computer-implemented method of claim 10, further comprising:
generating, by the system, a Pauli decomposition of the truncated Magnus expansion.

13. The computer-implemented method of claim 10, further comprising:
reformulating, by the system, the time evolution as a product of a first operator and a second operator, wherein the first operator describes a time evolution under the first Hamiltonian, and wherein the second operator is a time evolution generated by an interaction-picture Hamiltonian.

14. The computer-implemented method of claim 13, further comprising:
employing, by the system, the truncated Magnus expansion to approximate the time evolution generated by the interaction-picture Hamiltonian.

15. The computer-implemented method of claim 12, further comprising:
employing, by the system, Trotter formulas to implement the time evolution under the first Hamiltonian and the Pauli decomposition of the truncated Magnus expansion in the quantum circuit; and
executing, by the system, the quantum circuit using a quantum processor to simulate the quantum model of the quantum system.

16. A computer program product facilitating a process to reduce error of quantum simulation using Magnus expansion, the computer program product comprising a computer readable storage medium having program instructions embodied therewith, the program instructions executable by a processor to cause the processor to:
generate, by the processor, a quantum circuit that represents a quantum model of a quantum system, wherein generating of the quantum circuit comprises:
decomposing, by the processor, a time-independent Hamiltonian that describes the quantum system into a first Hamiltonian and a second Hamiltonian; and
employing, by the processor, a Magnus expansion in an interaction picture of the first Hamiltonian to approximate a time evolution of the quantum system under a time-dependent Hamiltonian.

17. The computer program product of claim 16, wherein the program instructions are further executable by the processor to cause the processor to:
truncate, by the processor, the Magnus expansion by a truncation parameter to create a truncated Magnus expansion; and
identify, by the processor, the truncation parameter informed by Lieb-Robinson bounds.

18. The computer program product of claim 17, wherein the program instructions are further executable by the processor to cause the processor to:
generate, by the processor, a Pauli decomposition of the truncated Magnus expansion.

19. The computer program product of claim 17, wherein the program instructions are further executable by the processor to cause the processor to:
reformulate, by the processor, the time evolution as a product of a first operator and a second operator, wherein the first operator describes a time evolution under the first Hamiltonian, and wherein the second operator is a time evolution generated by an interaction-picture Hamiltonian; and
employ, by the processor, the truncated Magnus expansion to approximate the time evolution generated by the interaction-picture Hamiltonian.

20. The computer program product of claim 18, wherein the program instructions are further executable by the processor to cause the processor to:
employ, by the processor, Trotter formulas to implement the time evolution under the first Hamiltonian and the Pauli decomposition of the truncated Magnus expansion in the quantum circuit; and
execute, by the processor, the quantum circuit using a quantum processor to simulate the quantum model of the quantum system.
